(19) United States
(12) Patent Application Publication
(10) Pub. No.: US 2006/0101971 A1
(43) Pub. Date: May 18, 2006

(54) Miter saw workpiece stop

(76) Inventor: Vance Roe, Arlington, TN (US)

Correspondence Address: THE BLACK & DECKER CORPORATION, 701 EAST JOPPA ROAD, TW199, TOWSON, MD, 21286, US

(21) Appl. No.: 11/048,636

(22) Filed: Jan. 31, 2005

Related U.S. Application Data
(60) Provisional application No. 60/540,846, filed on Jan. 30, 2004.

(51) Int. Cl. B26D 5/08

(52) U.S. Cl. 83/581

(57) ABSTRACT

A workpiece stop system for utilization in power tools such as a miter saw. The miter saw includes a support surface for supporting a workpiece to be cut. A positioning fence is coupled to the support surface for positioning the workpiece. The workpiece stop system is integrated with the support surface to permit efficient workpiece position and storage when the stop system is not being utilized. An adjustable positioning member is configured to slide within a slot formed in the support system. The adjustable positioning member includes a tab portion which is capable of being orientated in an engaging orientation in which the tab extends beyond the support surface or the adjustable positioning member may be inverted into a stowed orientation so as not to interfere with operation of the power tool when workpiece positioning is not required. A securing member is included for fixedly securing the adjustable positioning member at a desired position along the slot or when the adjustable positioning member is orientated in a stowed position.

### CROSS REFERENCE

The present application claims priority under 35 U.S.C. §119(e) to U.S. Provisional Patent Ser. No. 60/540,846, entitled: Miter Saw Workpiece Stop, filed on Jan. 30, 2004 which is hereby incorporated by reference in its entirety.

### FIELD OF THE INVENTION

The present invention relates to the field of woodworking and particularly to a miter saw having a workpiece stop for orientating a workpiece.

### BACKGROUND OF THE INVENTION

Fine woodworking requires precise cuts in order to form intricate details and to ensure a tight fit. Precision is of the utmost concern when cutting molding. When cutting crown molding, trim molding, or the like the workpiece is angled between a positioning fence, which extends perpendicular to a support surface, and the support surface on which the workpiece rests during cutting. In these instances, a miter saw or a miter saw having beveling capability is typically utilized. Proper workpiece positioning during cutting is essential to generating a high quality finished product. For example, not only may the workpiece be mitered, but also include a bevel-cut component, thereby resulting in a workpiece end which is angled along two planes. If, the workpiece is not properly positioned, the finished joint may not align, or require that the woodworker sand the end. These types of cut may be especially discouraging or time consuming for a novice user.

Previous systems fail to provide an efficient method and system for positioning a workpiece. For example, a user may be forced to utilize a removable clamp or stop which may become misplaced or forgotten. Additionally, previous devices may be difficult to set-up. Other stop devices may be cumbersome to adjust. Additionally, still further systems may interfere when cutting a large dimension workpiece when the stop device is assembled on the saw. In some instances, users may attempt to utilize a standard clamp which may be difficult to position or extend into the user's space in front of the saw.

Therefore, it would be desirable to provide an apparatus for securing a workpiece in a desired orientation during cutting operations.

### SUMMARY OF THE INVENTION

Accordingly, the present invention is directed to a workpiece stop system for utilization in power tools such as a miter saw. The miter saw includes a support surface for supporting a workpiece to be cut. A positioning fence is coupled to the support surface for positioning the workpiece. The workpiece stop system is integrated with the support surface to permit efficient workpiece position and storage when the stop system is not being utilized. An adjustable positioning member is configured to slide within a slot formed in the support system. The adjustable positioning member includes a tab portion which is capable of being orientated in an engaging orientation in which the tab extends beyond the support surface or the adjustable positioning member may be inverted into a stowed orientation so as not to interfere with operation of the power tool when workpiece positioning is not required. A securing member is included for fixedly securing the adjustable positioning member at a desired position along the slot or when the adjustable positioning member is orientated in a stowed position.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an isometric view of a miter saw including a workpiece stop in accordance with the present invention;

FIG. 2 is an isometric view of a miter saw including a stop in accordance with present invention wherein the stop is engaging a workpiece;

FIG. 3 is an exploded view of a miter saw including a workpiece positioning system in which the adjustable positioning member is disposed in an engaging orientation; and

FIG. 4 is an exploded view of a miter saw including a workpiece positioning system in which the adjustable positioning member is disposed in an stowed orientation.

### DETAILED DESCRIPTION OF THE INVENTION

Reference will now be made in detail to the presently preferred embodiments of the invention, examples of which are illustrated in the accompanying drawings. It is to be appreciated that corresponding reference numbers refer to generally corresponding structures.

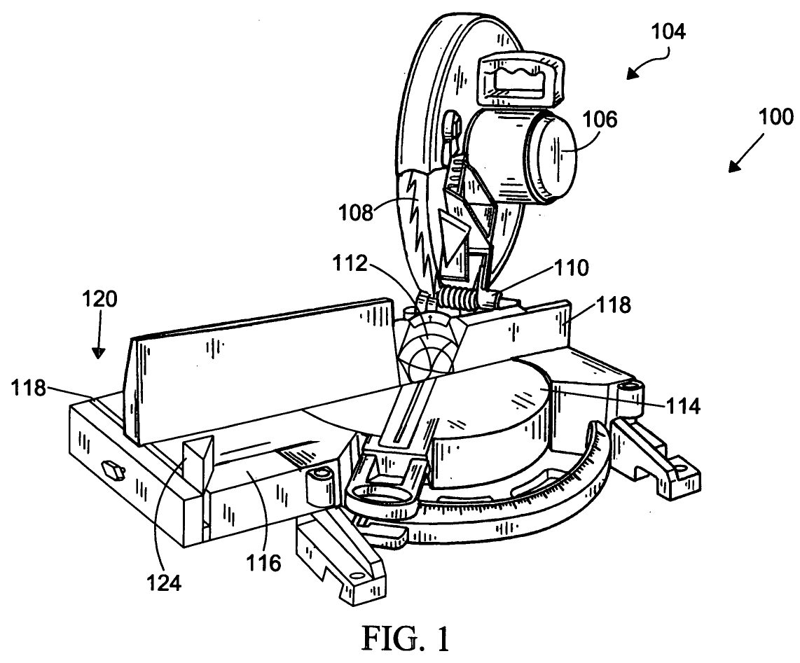

Referring to FIG. 1, a power tool in accordance with an aspect of the present invention is discussed. In the present embodiment, a power miter saw 100 with beveling capability is disclosed. In further embodiments, the workpiece stop system 102 of the present invention may be included in a variety of power tools such as: radial arm saws, standard chop-type miter saws (standard or bevel), sliding or rail mounted miter saws (standard or bevel), drill presses, sanding assemblies such as a disk sander with support table, and the like.

A cutting assembly 104 having a motor 106 for driving a working tool (e.g., rotating a circular saw blade 108) is included in the saw 100. Those of skill in the art will appreciate that other types of power tools, such as a drill press, will have various corresponding working tool elements. For example, the cutting assembly 104 is pivotally mounted via a pivot pin 110 to a bevel assembly 112. Preferably, the cutting assembly 104 is biased by a spring or the like away from a support surface 116 to permit workpiece positioning prior to cutting. In the present embodiment, a trunnion, included on a turntable 114, is implemented to permit angular adjustment of the saw blade 108 with respect to the support surface (i.e., bevel). In a standard miter saw (i.e., non-beveling), the cutting assembly 104 may be pivotally coupled directly to the turntable 114. The turntable 114 is adjustably coupled to the support surface in order to rotate thereby permitting angular adjustment of the saw blade with respect to a workpiece positioning fence 118. In the foregoing manner, a workpiece positioned along the fence may be cut at an angle. In the current example, the support surface is formed to function as a base for supporting the miter saw 100 when disposed on a support surface. In other examples, a support surface may be formed in a variety of configurations, as desired.

The workpiece fence 118 is coupled to the support surface so a user may position a workpiece against the fence during operation thus maintaining the workpiece in the desired orientation during cutting. Preferably, the workpiece positioning fence 118 extends perpendicular to the support surface 116 to aid accurate workpiece alignment. The workpiece positioning fence 118 may be formed with a portion integral (at least partially) to the support surface. In further embodiments, a positioning fence is coupled via a plurality of fasteners, an interlocking mechanical mechanism such as a keyway, or the like.

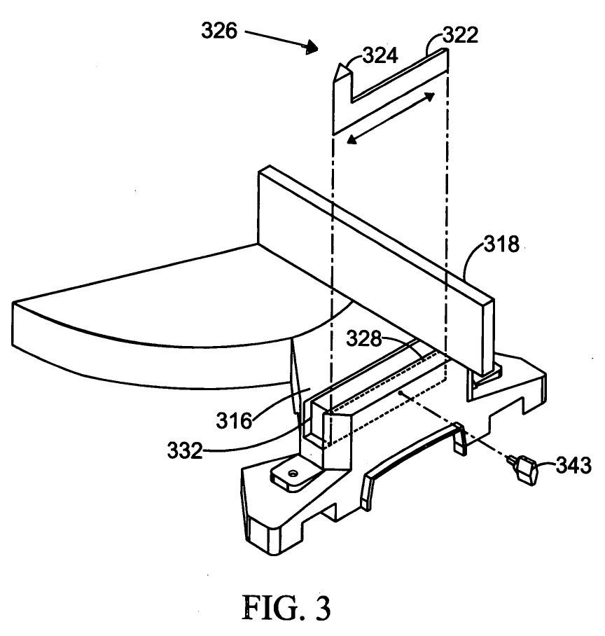

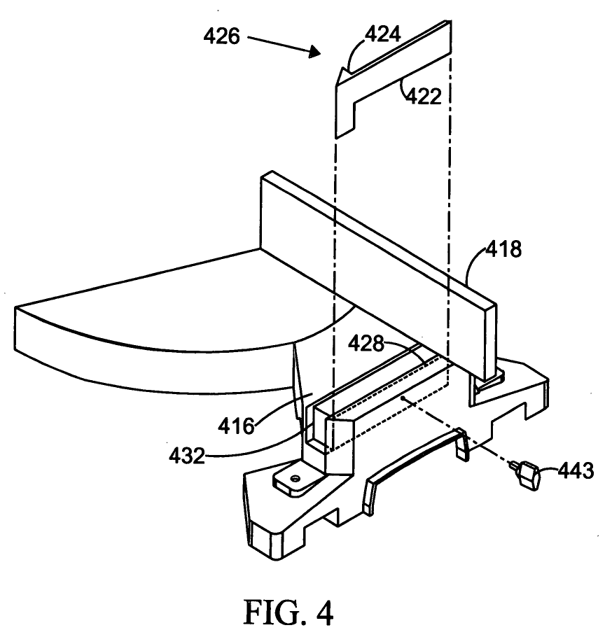

Referring to FIGS. 1, 3, and 4, a workpiece stop system 120 is included in the miter saw 100. In the present embodiments, a slot 128 is formed in the support surface 116 of the miter saw. As may be best observed in FIGS. 3 and 4 an elongated slot 328, or recess configured for receiving an adjustable positioning member 326, is included in the main support surface 316 of the saw. In the present embodiment, the adjustable positioning member 326 includes a main body portion 322 which is configured to slide within the slot 328 to obtain a variety of positions along the slot (e.g., establish a tab portion in various positions away from the workpiece positioning fence 318). The slot may extend through the rear of the support surface, i.e., through a lip in the support surface, generally towards the cutting assembly, to permit positioning the adjustable positioning member adjacent the fence 318.

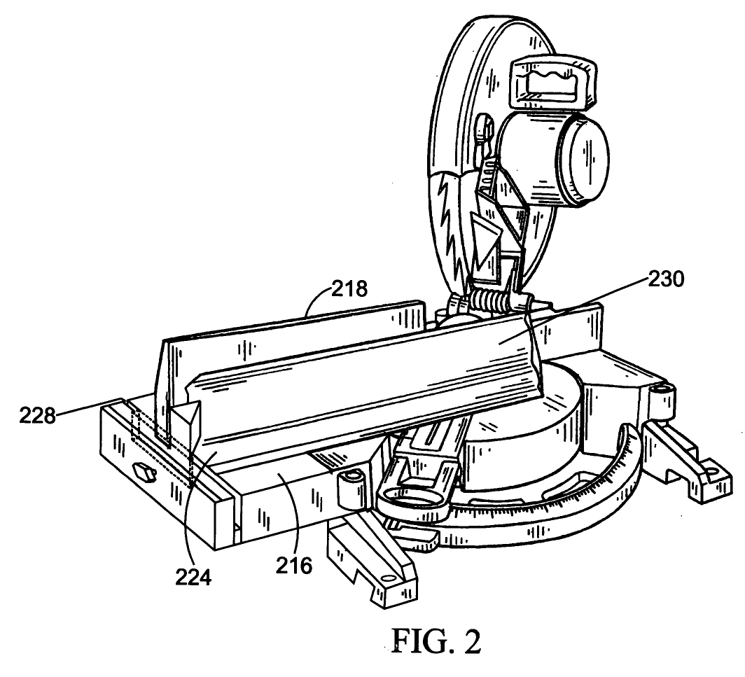

Referring to FIG. 2, during use, the adjustable positioning member (tab portion 224 may be observed) may be slid along the slot 228 to engage a workpiece 230 when the tab/adjustable positioning member is orientated in an engaging orientation (i.e., the tab extends beyond the primary plane of the support surface 216). In the foregoing manner, the workpiece 230 may be supported by the fence 218 and the support surface 216. A tab portion 224 extends from the main body portion for engaging a workpiece to be positioned. The tab portion 224 may be utilized to prevent the angular orientation of the workpiece from changing. Referring to FIGS. 1, 3, and 4, in various examples, the adjustable positioning member is formed from a unitary piece of stamped metal. The instant configuration may permit the formation of a folded tab portion which extends perpendicular to the main body portion 322 for simplified manufacture. Additionally, as the tab portion 324 extends generally beyond a plane encompassing the main body portion 322 the tab 324 may at least partially rest on the support surface. Those of skill in the art will appreciate that while the slot/main body portion are illustrated as generally rectangular, the slot/main body portion may be shaped as desired such as a rod extending in a generally circular aperture, the slot/main body portion having a hexagonal cross-section, or the like. In further embodiments, a tab and main portions may be coupled via a fastener, an adhesive or the like. Additionally, a variety of materials such as a rigid plastic may be implemented. In additional embodiments, a slot may be formed in an auxiliary support surface. For instance, an auxiliary wing forming a slot, connected to a primary support surface by a plurality of fasteners, is implemented to permit retro-fitting of an existing power tool with a workpiece stop system. Preferably, the slot 118 extends perpendicularly from the workpiece positioning fence. Aligning the slot in the previous manner permits adjusting the tab portion 324 along the support surface towards/away from the positioning fence such as if a measured distance away from the fence is desired. In further embodiments, the slot is aligned at an oblique angle to the workpiece. For example, a slot may extend diagonally (with respect to a side of the support surface) so that the tab is positionable towards/away from the working tool or the turntable to accommodate a small workpiece.

Referring to FIGS. 3 and 4, an adjustable positioning member 326 may be orientated in an engaging orientation (FIG. 3) so that the tab portion 324 is arranged to extend beyond the plane of the support surface 316. In further embodiments, the workpiece stop system is configured with an adjustable positioning member which extends away from the workpiece positioning fence 318. In the foregoing manner, the workpiece positioning system (except for the tab portion 324) may be disposed within the support surface so as to not interfere with operation of the power tool. Referring to FIG. 4, in contrast, the adjustable positioning member 426 may be inverted such that the tab portion 424 is orientated in a stowed orientation so the tab does not extend beyond the support surface 416. Those of skill in the art will appreciate a full inversion or 180° (one hundred and eighty degree) may not be necessary if a cylindrical main body portion is implemented. In the foregoing example, the tab may be merely orientated within the support surface (e.g., the tab is orientated within a recess in the support surface) to prevent interference with operation when the stop is not implemented. Including an adjustable positioning member permits integration of the workpiece positioning system without interfering with subsequent operations. Additionally, the support surface 416 may include a stowage recess 432 formed adjacent the slot for at least partially accepting the tab portion 424 included on the adjustable positioning member 426. In this manner, the workpiece stop system components may be efficiently stored when not in use.

With continued reference to FIGS. 3 and 4, in further embodiments, a securing member is included in the workpiece stop system. In the referenced examples, the securing member is a thumb screw 343 which is configured to thread into a corresponding aperture included in the support surface 316 so that an end of the thumb screw engages with the main body portion 322 to frictionally secure the adjustable positioning member 326 in a desired position. Preferably, a thumb screw 343 extends generally perpendicular to the main body portion provide for sufficient contact between an end of the thumb screw and the main body portion. In the present embodiment, the adjustable positioning member 326 may be variously positioned along the slot 328. Additionally, a thumb screw 443 may be utilized to secure the adjustable positioning member in a stowed orientation (as may be generally observed in FIG. 4). In further embodiments, a series of detents may be included for allowing indexed positioning such as to allow a user to rapidly secure the adjustable body member at a pre-selected distance. For instance, a detent is included on the main body portion a commonly utilized distance from the positioning fence or the like. Those of skill in the art will appreciate that a variety of securing devices such as a spring biased pin, a leaf spring engaging member, a cam lock, and the like may be implemented without departing from the spirit and scope of the present invention.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A power tool, comprising:
a support surface for at least partially supporting a workpiece, the support surface defining a slot;
a positioning fence extending substantially perpendicular to the support surface;
an adjustable positioning member, the adjustable positioning member being constructed with an elongated main body portion configured to be adjustably disposed generally within the slot and a tab portion extending from the main body portion such that the tab portion extends beyond the support surface when disposed in an engaging orientation; and
a securing member constructed to secure the adjustable positioning member with respect to the support surface,
wherein the adjustable positioning member is configured such that the positioning member is capable of being inverted so that the tab portion is orientated into a stowed orientation.

2. The power tool of claim 1, wherein the power tool is a motor miter saw.

3. The power tool of claim 1, wherein the support surface defines a recess capable of receiving the tab portion when disposed in a stowed orientation.

4. The power tool of claim 1, wherein the securing member is a thumb screw.

5. The power tool of claim 1, wherein the main body portion and the tab portion included in the adjustable positioning member are unitary.

6. The power tool of claim 1, wherein the support surface is an auxiliary support surface configured to be coupled to a main support surface of an existing power tool.

7. The power tool of claim 1, wherein the tab portion of the adjustable positioning member extends perpendicular to the main body portion.

8. A power miter saw, comprising:
a motor driven cutting assembly;
a support surface for at least partially supporting a workpiece to be cut, the support surface defining an elongated slot;
a turntable rotatably coupled to the support surface so as to adjust the angular orientation of the cutting assembly;
a positioning fence extending substantially perpendicular to both the support surface and the slot defined within the support surface;
an adjustable positioning member, the adjustable positioning member being constructed with an elongated main body portion configured to be adjustably disposed generally within the elongated slot and a tab portion extending from the main body portion such that the tab portion extends beyond the support surface when disposed in an engaging orientation; and
a securing member constructed to secure the adjustable positioning member with respect to the support surface,
wherein the adjustable positioning member is configured such that the positioning member is capable of being inverted whereby the tab portion is orientated into a stowed orientation.

9. The power miter saw of claim 8, wherein the cutting assembly is configured to bevel with respect to the support surface.

10. The power miter saw of claim 8, wherein the support surface defines a recess capable of receiving the tab portion when disposed in a stowed orientation.

11. The power miter saw of claim 8, wherein the securing member is a thumb screw.

12. The power miter saw of claim 8, wherein the main body portion and the tab portion included in the adjustable positioning member are unitary.

13. The power miter saw of claim 8, wherein the tab portion extends perpendicular to main body portion.

14. A miter saw, comprising:
a motor powered cutting assembly;
a support surface for at least partially supporting a workpiece to be cut;
a turntable rotatably coupled to the support surface so as to adjust the angular orientation of the cutting assembly;
a positioning fence extending substantially perpendicular to the support surface; and means for positioning the workpiece to be cut, the positioning means being primarily integrated into the support surface, the positioning means being configured to be orientated in an engaging orientation and a stowed orientation which is inverted from the engaging orientation.

15. The miter saw of claim 14, wherein the cutting assembly is configured to bevel with respect to the support surface.

16. The miter saw of claim 14, further comprising means for securing the positioning means in a desired position.

17. The miter saw of claim 16, wherein the securing means is a thumb screw.

18. The miter saw of claim 14, wherein the positioning means is configured for sliding manipulation.

19. The miter saw of claim 18, wherein the positioning means is configured to be positioned at least one of towards the positioning fence or away from the positioning fence.

20. The miter saw of claim 14, wherein the positioning means is configured to be perpendicularly positionable to the positioning fence.
